(19) United States
(12) Patent Application Publication
(10) Pub. No.: US 2024/0244429 A1
(43) Pub. Date: Jul. 18, 2024

(54) JOINT AUTHENTICATION FOR PRIVATE NETWORK

(71) Applicant: Telefonaktiebolaget LM Ericsson (publ), Stockholm (SE)

(72) Inventors: Xin NIE, Shanghai (CN); Bo ZHONG, Beijing (CN); Weiqiang JIANG, Beijing (CN); Jun WU, Shanghai (CN)

(73) Assignee: Telefonaktiebolaget LM Ericsson (publ), Stockholm (SE)

(21) Appl. No.: 18/290,237

(22) PCT Filed: May 13, 2021
(86) PCT No.: PCT/CN2021/093591

§ 371 Date: Nov. 10, 2023

(51) Int. Cl. H04W 12/06; H04W 12/08

(52) U.S. Cl. CPC H04W 12/06; H04W 12/08

(57) ABSTRACT

The present disclosure is related to network nodes and methods at the network nodes for jointly authenticating a user equipment (UE). A method at a first network node in a first network for jointly authenticating a CE in the first network and a second network comprises: receiving, from a second network node in the second network, a first authentication request for the UE: determining whether the UE is successfully authenticated or not at least partially based on one or more authentication configurations for the first network: and transmitting, to the second network node, a first authentication response indicating whether the UE is successfully authenticated or not based on a result of the determination.

### TECHNICAL FIELD

The present disclosure is related to the field of telecommunication, and in particular, network nodes and methods at the network nodes for jointly authenticating a user equipment (UE).

### BACKGROUND

A private mobile network may be a 5G system optimized for a specific industrial or enterprise use case (like Industrial Internet of Things, IIOT), where specific requirements play an important role (like QoS, latency, mobility, security). There are different options for the implementation of those local/dedicated networks. They can be owned/managed by an Mobile Network Operator (MNO), an Enterprise itself, or a venue owner, and can utilize licensed, license-shared (using schemes like Citizens Broadband Radio Services (CBRS), License Shared Access (LSA)), or unlicensed (with schemes like License Assisted Access (LAA), New Radio—Unlicensed (NR-U)) spectrum. What is important though, is the privacy aspect and carrier-grade security enabled by the 3GPP features. There are various high-level deployment options, ranging from completely standalone, through somehow integrated to the public network of an MNO, up to a network slice option, which is specific to 5G.

A standalone private mobile network is a mobile network deployed at the enterprise, completely isolated from the public network provided by MNO. Nothing prevents the MNO to deploy such independent networks, but the important thing is, that those networks are not relying on and do not interact with the MNO's large scale network. In such a case, the enterprise stores user and subscription databases locally. Also, the control of the network and data services are handled locally by the enterprise. Therefore, in this option, the network operates on a dedicated spectrum (or use unlicensed).

RAN and signaling shared option is where the services are handled locally within the enterprise, while the RAN (and spectrum) is shared with the public network. Network and user control is also handled by the MNO. Thus, the N2 interface is terminated at the 5GC within the public network domain.

In the network slice option, the slicing concept introduced in the 5G standardization is used to realize a virtual network for a specific application, which is logically separated from other virtual networks. In this implementation, resources are isolated such that the service level agreement (SLA) for a specific enterprise is kept safe and does not interfere with other slices and vice versa.

### SUMMARY

According to a first aspect of the present disclosure, a method at a first network node in a first network for jointly authenticating a user equipment (UE) in the first network and a second network is provided. The method comprises: receiving, from a second network node in the second network, a first authentication request for the UE; determining whether the UE is successfully authenticated or not at least partially based on one or more authentication configurations for the first network; and transmitting, to the second network node, a first authentication response indicating whether the UE is successfully authenticated or not based on a result of the determination.

In some embodiments, before the step of determining whether the UE is successfully authenticated or not, the method further comprises: transmitting, to a third network node at which the one or more authentication configurations are managed, an authentication configuration request for the UE; and receiving, from the third network node, an authentication configuration response comprising at least an authentication vector for authenticating the UE. In some embodiments, before the step of determining whether the UE is successfully authenticated or not, the method further comprises: transmitting, to the second network node, a second authentication request comprising a challenge for the UE, which is generated at least partially based on the authentication vector received from the third network node; and receiving, from the second network node, a second authentication response comprising a response to the challenge. In some embodiments, the step of determining whether the UE is successfully authenticated or not comprises: comparing the response received from the second network node and a correct response which is received in the authentication configuration response from the third network node or calculated at the first network node; and determining that the UE is successfully authenticated or not based on the comparison.

In some embodiments, the first authentication request and the first authentication response are generated according to a first authentication framework, and the second authentication request and the second authentication response are generated according to a second authentication framework different from the first authentication framework. In some embodiments, the first authentication framework is 5th Generation—Authentication and Key Agreement (5G-AKA) or Extensible Authentication Protocol—Authentication and Key Agreement (EAP-AKA′), and the second authentication framework is a Lightweight Directory Access Protocol (LDAP)-based framework. In some embodiments, before transmitting, to a third network node at which the one or more authentication configurations are managed, an authentication configuration request for the UE, the method further comprises: generating the authentication configuration request from the first authentication request.

In some embodiments, after the step of transmitting, to the second network node, a first authentication response, the method further comprises: transmitting, to the third network node, an authentication result confirmation request indicating the result of the authentication for the UE; and receiving, from the third network node, an authentication result confirmation response acknowledging the result of the authentication for the UE. In some embodiments, the first network node is a Private Subscriber Authentication Function (PSAF), the second network node is an Access and Mobility Management Function (AMF)/Security Anchor Function (SEAF), and the third network node is an LDAP server in the first network. In some embodiments, the first network node is a Private Subscriber Authentication Function (PSAF), the second network node is an Access and Mobility Management Function (AMF)/Security Anchor Function (SEAF), and the third network node is a Unified Data Management (UDM) in the second network. In some embodiments, the first network is a private network operated by an enterprise, and the second network is a network operated by a Mobile Network Operator (MNO).

According to a second aspect of the present disclosure, a first network node is provided. The first network node comprises: a processor; a memory storing instructions which, when executed by the processor, cause the processor to perform any of the methods of the first aspect.

According to a third aspect of the present disclosure, a method at a second network node in a second network for jointly authenticating a user equipment (UE) in a first network and the second network is provided. The method comprises: receiving, from a fourth network node in the first network, a registration request for the UE; transmitting, to a first network node in the first network, a first authentication request for the UE; receiving, from the first network node, a first authentication response indicating whether the UE is successfully authenticated or not based on a result of the determination; and transmitting, to the fourth network node, a registration response at least partially based on the first authentication response received from the first network node.

In some embodiments, before the step of receiving, from the first network node, a first authentication response, the method further comprises: receiving, from the first network node, a second authentication request comprising a challenge for the UE; transmitting, to the fourth network node, the second authentication request; receiving, from the fourth network node, a second authentication response comprising a response to the challenge; and transmitting, to the first network node, the second authentication response. In some embodiments, the first network node is a Private Subscriber Authentication Function (PSAF), the second network node is an Access and Mobility Management Function (AMF)/Security Anchor Function (SEAF), and the fourth network node is a radio access network (RAN) node. In some embodiments, the first network is a private network operated by an enterprise, and the second network is a network operated by a Mobile Network Operator (MNO).

According to a fourth aspect of the present disclosure, a second network node is provided. The second network node comprises: a processor; a memory storing instructions which, when executed by the processor, cause the processor to perform any of the methods of the third aspect.

According to a fifth aspect of the present disclosure, a computer program comprising instructions is provided. The instructions, when executed by at least one processor, cause the at least one processor to carry out the method of any of the first and third aspects.

According to a third aspect of the present disclosure, a carrier containing the computer program of the fifth aspect. In some embodiments, the carrier is one of an electronic signal, optical signal, radio signal, or computer readable storage medium.

According to a third aspect of the present disclosure, a system for jointly authenticating user equipments (UEs) in a first network and a second network is provided. The system comprises: one or more UEs which are managed collectively by the first network and the second network; a first network node of the second aspect, which is located in the first network; a second network node of the fourth aspect, which is located in the second network.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is an overview diagram illustrating a typical 5G New Radio (NR) network architecture in the related art.

FIG. 2 is an overview diagram illustrating an exemplary private network which is somehow integrated with an exemplary 5G NR network according to an embodiment of the present disclosure is applicable.

FIG. 3 is a diagram illustrating an exemplary procedure for joint authentication according to an embodiment of the present disclosure.

FIG. 4 is a diagram illustrating another exemplary procedure for joint authentication according to another embodiment of the present disclosure.

FIG. 5 is a flow chart illustrating an exemplary method at a first network node for jointly authenticating a user equipment (UE) according to an embodiment of the present disclosure.

FIG. 6 is a flow chart illustrating an exemplary method at a second network node for jointly authenticating a UE according to an embodiment of the present disclosure.

FIG. 7 schematically shows an embodiment of an arrangement which may be used in a network node according to an embodiment of the present disclosure.

FIG. 8 is a block diagram of an exemplary first network node according to an embodiment of the present disclosure.

FIG. 9 is a block diagram of an exemplary second network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as joint authentication for a private network is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IOT device, a vehicle, or any other equivalents. For another example, the term “network node” used herein may refer to a base station, a base transceiver station, an access point, a hot spot, a NodeB (NB), an evolved NodeB (eNB), a gNB, a network element, an access network (AN) node, a core network (CN) node, or any other equivalents. Further, the term “node” used herein may refer to a UE, a functional entity, a network entity, a network element, a network equipment, or any other equivalents.

Further, following 3GPP documents are incorporated herein by reference in their entireties:
3GPP TS 23.502 V16.8.0 (2021-03), Technical Specification, 3rd Generation Partnership Project; Technical Specification Group Services and System Aspects; Procedures for the 5G System (5GS); Stage 2 (Release 16); and
3GPP TS 33.501 V16.6.0 (2021-03), Technical Specification, 3rd Generation Partnership Project; Technical Specification Group Services and System Aspects; Security architecture and procedures for 5G system (Release 16).

Before a detailed description of some embodiments of the present disclosure is given, some basic knowledge of 5G system will be first introduced.

The 5G Core Network has been designed around services that are invoked using a standard Application Programming Interface (API). On the surface, the 5G architecture looks very different from the 4G Evolved Packet Core (EPC) but on close inspection, one can see the evolution from the 4G architecture to the 5G architecture.

For example, the 5G core has evolved from the 4G EPC in two steps:
Control and User Plane Separation (CUPS) of the 4G EPC; and
Reorganizing the 4G EPC CUPS functions into services.

### Cups

The introduction of control and user plane separation in the 4G EPC is the first step towards the 5G architecture. The Serving GateWay (SGW) and Packet Data Network (PDN) GateWay (PGW) functions were split into a control and data plane component:

$$\begin{matrix}SGW \to SGW - C and SGW - U \\ PGW \to PGW - C and PGW - U\end{matrix}$$

### Reorganization to Services

With the separation of control and user plane functions, the split functions are reorganized into new network functions, such as Access and Mobility Function (AMF), Session Management Function (SMF), User Plane Function (UPF), etc. In general, an AMF in 5G provides most of the functions which were previously performed by a Mobility Management Entity (MME) in 4G, an SMF provides rest of the functions which were previously provided by the MME in addition to the control plane (CP) functions which were previously provided by SGW and PGW, and a UPF provides the user plane (UP) functions which were previously provided by SGW and PGW. In such a manner, the 4G EPC components have been reorganized into service-oriented functions. Therefore, any reference to a network function defined for 5G may also be applicable to a node defined for 4G or any other appropriate telecommunication technologies. For example, when “SMF” is recited in some embodiments, “PGW-C” or “SGW-C” may be equally applicable. For example, when “UPF” is recited in some embodiments, “PGW-U” or “SGW-U” may be equally applicable.

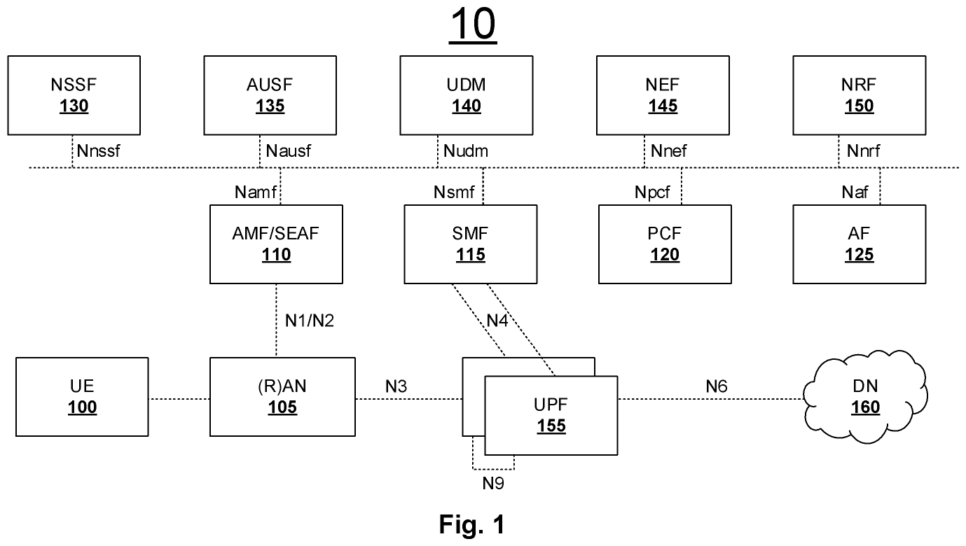

FIG. 1 is an overview diagram illustrating a typical 5G New Radio (NR) network architecture 10 in the related art. As shown in FIG. 1, the network 10 may comprise one or more UEs 100 and a (radio) access network ((R)AN) 105, which could be a base station, a Node B, an evolved NodeB (eNB), a gNB, or any entity which provides access to the UEs 100. Further, the network 10 may comprise its core network portion comprising (but not limited to) an AMF 110, an SMF 115, a Policy Control Function (PCF) 120, an Application Function (AF) 125, a Network Slice Selection Function (NSSF) 130, an Authentication Server Function (AUSF) 135, a Unified Data Management (UDM) 140, a Network Exposure Function (NEF) 145, a Network Repository Function (NRF) 150, and one or more UPFs 155. As shown in FIG. 1, these entities may communicate with each other via the service-based interfaces, such as, Namf, Nsmf, Npcf, etc. and/or the reference points, such as, N1, N2, N3, N6, N9, etc.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

Here, some of the functions shown in FIG. 1, such as AMF 110, AUSF 135, and UDM 140, which may be involved in the embodiments of the present disclosure will be described in detail below.

Referring to FIG. 1, the AMF 110 may provide most of the functions that the MME provides in a 4G network as mentioned above. Below please find a brief list of some of its functions:
Terminates the RAN CP interface (N2);
Non-access stratum (NAS) signaling;
NAS ciphering and integrity protection;
Mobility Management (MM) layer NAS termination;
Session Management (SM) layer NAS forwarding;
Authenticates UE;
Manages the security context;
Registration management;
Connection management;
Reachability management;
Mobility Management; and
Apply mobility related policies from PCF (e.g. mobility restrictions).

Further, the AMF 110 may also serves in the serving network as the anchor for security in 5G, and therefore it may be referred to as Security Anchor Function (SEAF) also.

Further, the AUSF 135 may support the following functionality:
Supports authentication for 3GPP access and untrusted non-3GPP access as specified in 3GPP TS 33.501.

Further, the UDM 140 may comprise support for the following functionality:
Generation of 3GPP Authentication and Key Agreement (AKA) Authentication Credentials.
User Identification Handling (e.g. storage and management of SUPI for each subscriber in the 5G system).
Support of de-concealment of privacy-protected subscription identifier (SUCI).
Access authorization based on subscription data (e.g. roaming restrictions).
UE's Serving NF Registration Management (e.g. storing serving AMF for UE, storing serving SMF for UE's PDU Session).
Support to service/session continuity e.g. by keeping SMF/DNN assignment of ongoing sessions.
Mobile terminated—Short Message Service (MT-SMS) delivery support.
Lawful Intercept (LI) Functionality (especially in outbound roaming case where UDM is the only point of contact for LI).
Subscription management.
SMS management.
5GLAN group management handling.
Support of external parameter provisioning (Expected UE Behavior parameters or Network Configuration parameters).

As shown in FIG. 1, when the UE 100 is trying to access the network 10, an authentication procedure will typically be performed between the UE 100 and multiple network nodes comprising but not limited to the RAN 105, the AMF 110, the AUSF 135 and the UDM 140.

When a private mobile network is deployed at an enterprise, for example, when RAN and signaling shared option or the network slice option is selected, an authentication procedure for any mobile devices that are trying access the network has to be performed by the MNO rather than by the enterprise itself. However, the enterprise IT environment usually has its own existing user and equipment authentication process and methods such as TPM to control the access to their IT infrastructure. In other words, it might be not as safe as expected by the enterprise when the authentication procedure is performed completely by the network nodes (such as, AMF/AUSF/UDM) owned and operated by the MNO. On the other hand, the MNO would not have the authentication procedure performed completely and independently by the enterprise itself, in which case the MNO may lose its control of the mobile subscribers. Therefore, a joint authentication mechanism for such a private network may be required.

In some embodiments of the present disclosure, a comprehensive method for jointly authenticating both the cellular user equipment together with the enterprise equipment in a private enterprise network may be provided.

Generally speaking, the problem may be solved or at least partially alleviated by creating a process and necessary components to combine the authentication functions and components of cellular networks to usual enterprise authentication components, such that only when the joint authentication is successful, the enterprise IT equipment can then be allowed to access the private cellular network.

In some embodiments, the method may be achieved by providing an additional interface between the authentication function in cellular network and the authentication component in enterprise, to allow one additional layer of authentication to check the identify of both SIM card and the IT equipment. This may help solve the problem of allowing direct access to a private network by SIM-based authentication only.

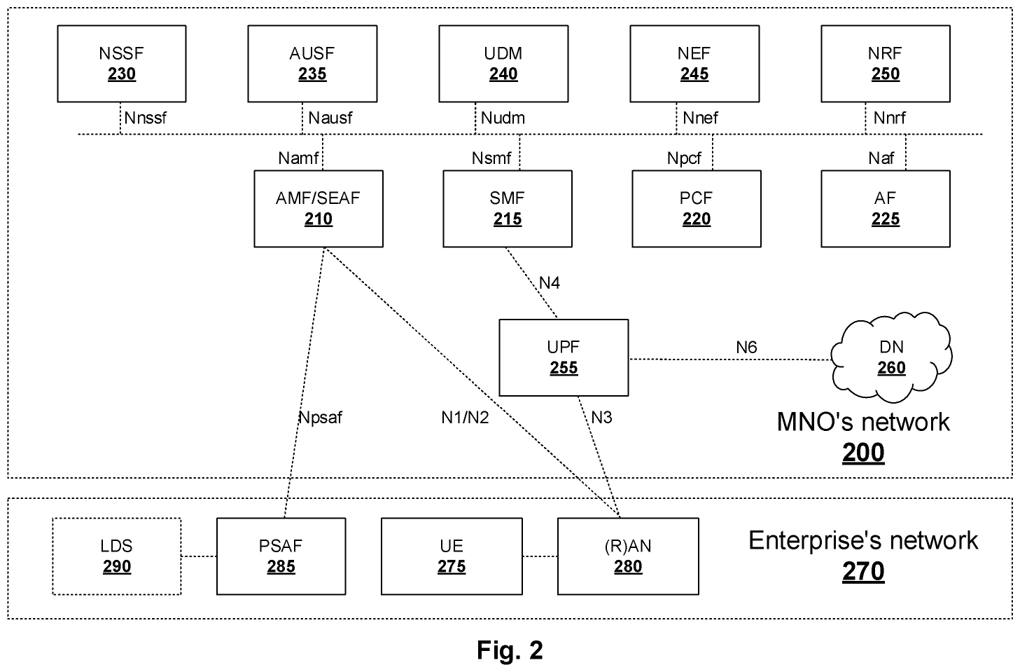

Next, a detailed description of some embodiments of the present disclosure will be given with reference to FIG. 2 to FIG. 9.

FIG. 2 is an overview diagram illustrating an exemplary private network 270 which is somehow integrated with an exemplary 5G NR network 200 according to an embodiment of the present disclosure is applicable. Please note that some of the network nodes are similar to those shown in FIG. 1, and therefore the detailed description thereof may be omitted for simplicity.

As shown in FIG. 2, the private enterprise network 270 may be integrated with the MNO's 5G NR network 200, such that some of the network nodes of the 5G NR network 200, such as the RAN 280, may be deployed in the enterprise's network 270. However, the present disclosure is not limited thereto. In some other embodiments, more network nodes, less network nodes, and/or different network nodes of the 5G NR network 200 may be deployed in the private network 270. In some other embodiments, the AMF 210 may be deployed in the private network 270. In some yet other embodiments, one or more UPF 255 may be deployed in the private network 270. In some further embodiments, one or more AF 225 may be deployed in the private network 270.

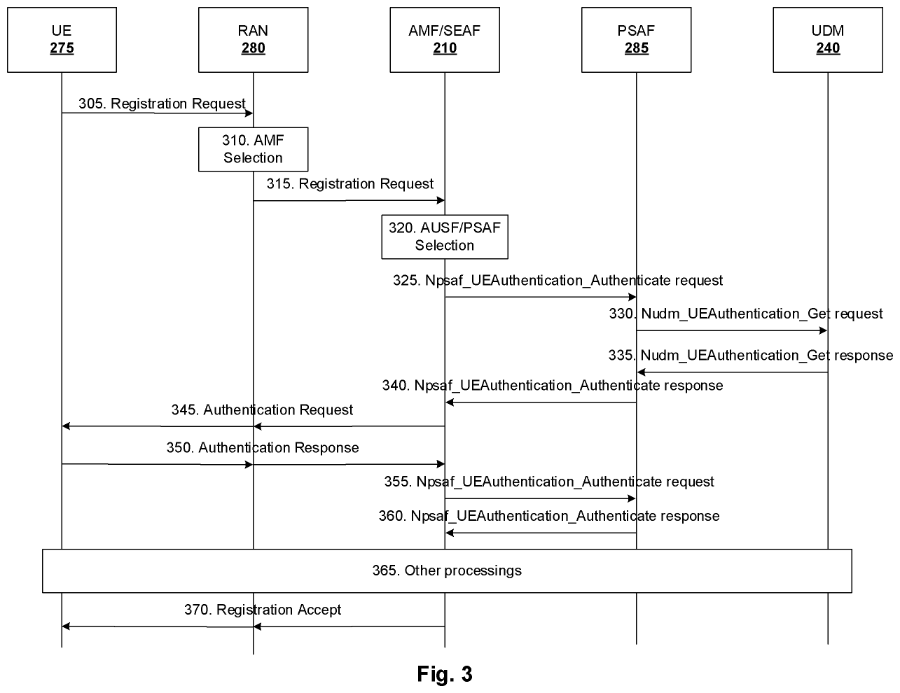

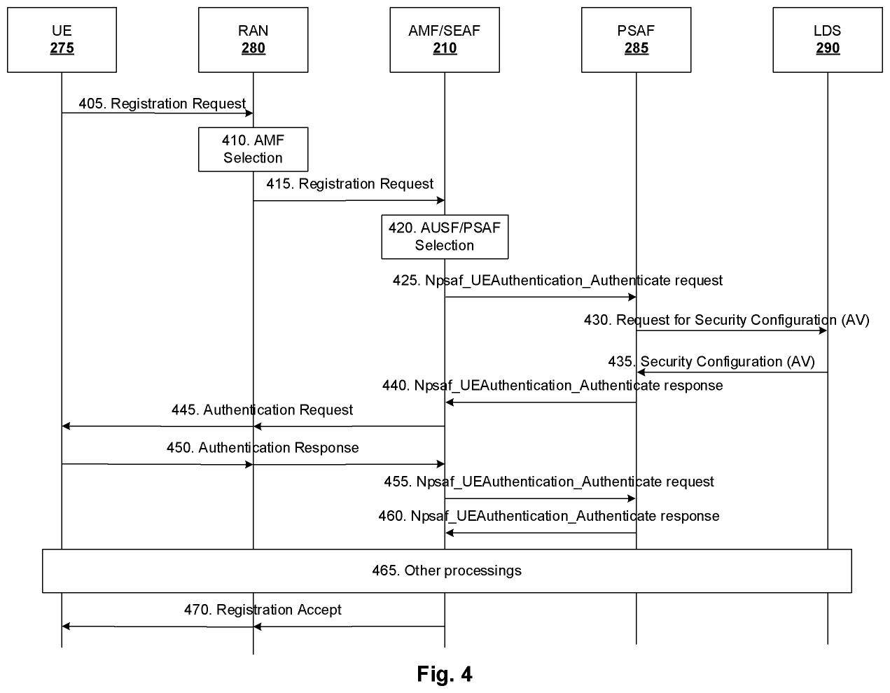

Further, as shown in FIG. 2, the private network 270 may further comprise a private subscriber authentication function (PSAF) 285 for jointly authenticating one or more UEs 275 in the private network 270 together with some network nodes, such as the AMF 210, the UDM 240, as will be detailed described below with reference to FIG. 3 and FIG. 4. The PSAF 285 may provide a service-based interface Npsaf, to enable other network nodes to consume its services. However, the present disclosure is not limited thereto, and some other interfaces or Application Programming Interface (API) may be provided.

Furthermore, as also shown in FIG. 2, the private network 270 may further comprise an optional module, Local Directory Service 290 for local directory services. In some embodiments, the LDS 290 may be one of Microsoft® Active Directory service, Lightweight Directory Access Protocol (LDAP) service, a Trusted Platform Module (TPM) service or any other service which may provide similar functionalities. In other words, any appropriate authentication mechanism may be used in the private network 270.

FIG. 3 is a diagram illustrating an exemplary procedure for joint authentication according to an embodiment of the present disclosure. As shown in FIG. 3, the UE 275 needs to register with the network 200/270 to get authorized to receive services, to enable mobility tracking and to enable reachability. In the embodiment shown in FIG. 3, the UE 275 is trying its initial registration with the network 200/270, and the present disclosure is not limited thereto.

At step 305, the UE 275 may transmit a Registration Request message with one or more AN parameters, such as Registration type, SUCI or 5G-GUTI or PEI, Security parameters, etc. In the case of NG-RAN, the AN parameters may further comprise Establishment cause. The Establishment cause may provide the reason for requesting the establishment of an RRC connection. The Registration type may indicate if the UE 275 wants to perform an Initial Registration, a Mobility Registration Update, a Periodic Registration Update or an Emergency Registration. Therefore, in the embodiment shown in FIG. 3, the registration type indicates that the UE 275 wants to perform an Initial Registration.

At step 310, upon reception of the Registration Request message, the RAN 280 may select an AMF for the UE 275, for example, the AMF 210. In some embodiments, the selection of the AMF 210 may be based on (R)AT and Requested NSSAI, if available. If the (R)AN 280 cannot select an appropriate AMF, it may forward the Registration Request to an AMF which has been configured, in (R)AN, to perform AMF selection.

At step 315, the RAN 280 may forward the Registration Request message to the selected AMF 210.

At step 320, the AMF 210 may decide to initiate UE authentication by invoking an AUSF or PSAF. In that case, the AMF 210 may select the PSAF 285 based on UE's identity, for example. In some other embodiments, the AMF 210 may select the PSAF 285 in response to determining that the registration request is received from the RAN 280 which is deployed in the enterprise network 270. In some yet other embodiments, the AMF 210 may select the PSAF 285 in response to determining that the registration request is received from the RAN 280 which is deployed in the enterprise network 270 and also based on the UE's identity. For example, when an enterprise UE (e.g., an IoT device owned and operated by the enterprise) is trying to access the RAN 280, the AMF 210 may decide to authenticate the enterprise UE with the PSAF 285. For another example, when a normal UE (e.g., a mobile phone carried by someone who is just passing by the RAN 280) is trying to access the RAN 280, the AMF 210 may decide to authenticate the normal UE with an AUSF (e.g., the AUSF 135 shown in FIG. 1). Generally speaking, the AMF 210 may determine a network node with which the UE 275 is to be authenticated based on one or more of factors comprising but not limited to UE's identity, RAN from which the request is received, a predetermined policy at the AMF 210, or any other factors.

At step 325, when the AMF/SEAF 210 determines that the PSAF 285 should be selected for authentication of the UE 275, it may invoke the Npsaf_UEAuthentication service by sending an Npsaf_UEAuthentication_Authenticate Request message to the PSAF 285.

In some embodiments, the Npsaf_UEAuthentication_Authenticate Request message may contain the identity of the UE 275. Further, the Npsaf_UEAuthentication_Authenticate Request may furthermore contain the serving network name. Please note that the local policy for the selection of the authentication method does not need to be on a per-UE basis, but can be the same for all UEs.

Upon receiving the Npsaf_UEAuthentication_Authenticate Request message, the PSAF 285 may check that the requesting AMF/SEAF 210 in the serving network is entitled to use the serving network name in the Npsaf_UEAuthentication_Authenticate Request by comparing the serving network name with the expected serving network name. The PSAF 285 may store the received serving network name temporarily. If the serving network is not authorized to use the serving network name, the PSAF 285 may respond with “serving network not authorized” in the Npsaf_UEAuthentication_Authenticate Response.

At step 330, an Nudm_UEAuthentication_Get Request may be sent from the PSAF 285 to the UDM 240 to request for some security configurations for the UE 275, and it may include the following information: the identity of the UE 275 and/or the serving network name.

Upon reception of the Nudm_UEAuthentication_Get Request, the UDM 240 may choose the authentication method at least partially based on the identity of the UE 275 and/or the serving network name. Please note that the Nudm_UEAuthentication_Get Response in reply to the Nudm_UEAuthentication_Get Request and the Npsaf_UEAuthentication_Authenticate Response message in reply to the Npsaf_UEAuthentication_Authenticate Request message will be described below.

In some embodiments, the UDM 240 may select the 5G AKA as the authentication method. However, the present disclosure is not limited thereto. In some other embodiments, the UDM 240 may select the EAP-AKA′, or any other authentication method.

When the 5G AKA is selected, the UDM 240 may create a 5G Home Environment (HE) Authentication Vector (AV). The UDM 240 may do this by generating an AV with the Authentication Management Field (AMF) separation bit set to “1”. The UDM 240 may then derive K_{PSAF} and calculate XRES*. Finally, the UDM 240 may create a 5G HE AV from RAND, AUTN, XRES*, and K_{PSAF}.

At step 335, the UDM 240 may then return required security configuration comprising the 5G HE AV to the PSAF 285 together with an indication that the 5G HE AV is to be used for 5G AKA in an Nudm_UEAuthentication_Get Response.

Upon reception of the 5G HE AV, the PSAF 285 may store the XRES* temporarily together with the received identity of the UE 275. The PSAF 285 may then generate the 5G AV from the 5G HE AV received from the UDM 240 by computing the HXRES* from XRES* and K_{SEAF} from K_{PSAF}, and replacing the XRES* with the HXRES* and K_{PSAF} with K_{SEAF} in the 5G HE AV.

The PSAF 285 may then remove the K_{SEAF} and return the 5G Serving Environment (SE) AV (RAND, AUTN, HXRES*) to the AMF/SEAF 210 in an Npsaf_UEAuthentication_Authenticate Response at step 340.

At step 345 the AMF/SEAF 210 may send RAND, AUTN to the UE 275 in a NAS message Authentication Request. This message may also comprise the ngKSI that will be used by the UE 275 and the AMF 210 to identify the K_{AMF} and the partial native security context that is created if the authentication is successful. The ME comprised of the UE 275 may forward the RAND and AUTN received in the NAS message Authentication Request to the USIM comprised in the UE 275.

Upon reception of the RAND and AUTN, the USIM may verify the freshness of the received values by checking whether AUTN can be accepted. If so, the USIM may compute a response RES. The USIM may return RES, CK, IK to the ME. If the USIM computes a Kc (i.e. GPRS Kc) from CK and IK using conversion function c3, and sends it to the ME, then the ME may ignore such GPRS Kc and not store the GPRS Kc on USIM or in ME. The ME then may compute RES* from RES. The ME may calculate K_{PSAF} from CK∥IK. The ME may calculate K_{SEAF} from K_{PSAF}. An ME accessing 5G shall check during authentication that the “separation bit” in the AMF field of AUTN is set to 1. The “separation bit” is bit 0 of the AMF field of AUTN. Please note that this separation bit in the AMF field of AUTN cannot be used anymore for operator specific purposes.

At step 350, the UE may return RES* to the AMF/SEAF 210 in a NAS message Authentication Response. Upon reception of the NAS message, the AMF/SEAF 210 may then compute HRES* from RES*, and the AMF/SEAF 210 may compare HRES* and HXRES*. If they coincide, the AMF/SEAF 210 may consider the authentication successful from the serving network point of view. If not, the AMF/SEAF 210 may return a message indicating an authentication failure to the UE 275 and/or the PASF 285. If the UE 275 is not reached, and the RES* is never received by the AMF/SEAF 210, the AMF/SEAF 210 may consider authentication as failed, and indicate a failure to the PSAF 285.

At step 355, the AMF/SEAF 210 may send RES*, as received from the UE 275, in an Npsaf_UEAuthentication_Authenticate Request message to the PSAF 285. When the PSAF 285 receives as authentication confirmation the Npsaf_UEAuthentication_Authenticate Request message including a RES* it may verify whether the 5G AV has expired. If the 5G AV has expired, the PSAF 285 may consider the authentication as unsuccessful from the home network point of view. Upon successful authentication, the PSAF 285 may store the K_{PSAF}. The PSAF 285 may compare the received RES* with the stored XRES*. If the RES* and XRES* are equal, the PSAF 285 may consider the authentication as successful from the home network point of view. The PSAF 285 may inform the UDM 240 about the authentication result.

At step 360, the PSAF 285 may indicate to the AMF/SEAF 210 in the Npsaf_UEAuthentication_Authenticate Response whether the authentication was successful or not from the home network point of view. If the authentication was successful, the K_{SEAF} may be sent to the AMF/SEAF 210 in the Npsaf_UEAuthentication_Authenticate Response.

If the authentication was successful, the key K_{SEAF} received in the Npsaf_UEAuthentication_Authenticate Response message may become the anchor key in the sense of the key hierarchy as specified in sub-clause 6.2 of the 3GPP TS 33.501.

At step 365, other processing for the UE's registration may be performed, such as, ME identity check, PCF communication for policy management, SMF communication for session management, etc. Since these processing are not directly related to the joint authentication procedure according to the embodiment shown in FIG. 3, the detailed description thereof is omitted for simplicity.

At step 370, the AMF 210 may transmit a Registration Accept message to the UE 275 to indicate that the registration and the authentication of the UE 275 is successful. Further, the AMF 210 may include a new 5G-GUTI in the Registration Accept message for the UE 275 due to the Initial Registration.

Although FIG. 3 shows a successful registration of the UE 275 with the private network 270, the present disclosure is not limited thereto. In some other embodiments, the AMF 210 may transmit a Registration Rejected message to the UE 275 to indicate that the registration of the UE 275 is failed, for example, due to a failed authentication of the UE 275.

With the join authentication method described above, security issue of allowing IT equipment accessing private cellular network only based on SIM-card authentication may be avoided. This is especially useful when physical SIM-card or cellular dongles are used to allow IT equipment to connect to private cellular network. Because when an authorized SIM-card is placed into an unauthorized IT equipment, this method can block it from the network. Further, a strong security may be maintained by combining both layers of authentication as a joint authentication. Only when a joint authentication is successful, the equipment may be allowed to access the private cellular network.

FIG. 4 is a diagram illustrating another exemplary procedure for joint authentication according to another embodiment of the present disclosure. Most of the steps shown in FIG. 4 are similar to their corresponding steps shown in FIG. 3 except for the steps 430 and 435, and therefore the detailed description of the similar steps is omitted for simplicity.

Unlike the step 330 shown in FIG. 3, at step 430, a request for a security configuration (e.g., a security configuration comprising an AV) may be sent from the PSAF 285 to the LDS 290 in the private network 270 rather than the UDM 240 in the MNO's network 200, and it may include the following information: the identity of the UE 275. Upon reception of the request, the LDS 290 may generate an authentication vector for the UE 275 at least partially based on the identity of the UE 275, for example, in a manner similar to that described above or in any other appropriate manner. At step 435, the LDS 290 may then return the security configuration comprising the generated AV to the PSAF 285 together with an indication that the generated AV is to be used for UE's authentication in a response message.

With the LDS 290, the enterprise may further improve its control of the UE 275 and integrate the authentication mechanism into its own subscriber management system. For example, when the LDS 290 is a Microsoft® Active Directory service or a LDAP service which is currently in charge of the domain authentication and management for the enterprise network comprising the private mobile network 270, the joint authentication procedure described with reference to FIG. 4 may enable the radio devices using 5G technology (e.g., UE 275) to be authenticated in a same manner as other enterprise devices (e.g., a desktop computer or a laptop running a Windows or Linux OS).

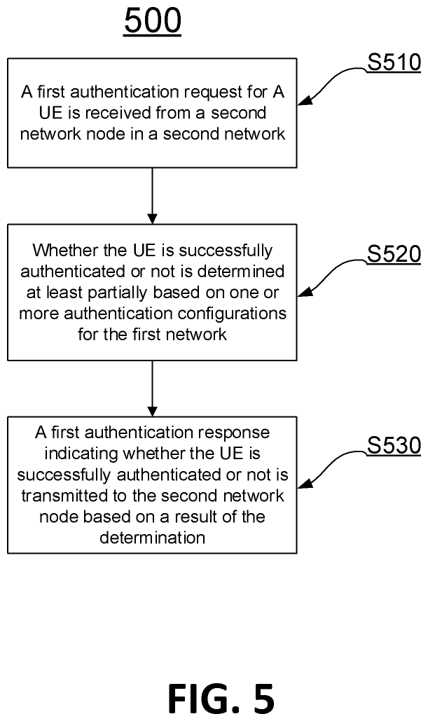

FIG. 5 is a flow chart of an exemplary method 500 at a first network node in a first network for jointly authenticating a UE in the first network and a second network according to an embodiment of the present disclosure. The method 500 may be performed at a first network element (e.g. the PSAF shown in FIG. 2-FIG. 4) for joint authentication. The method 500 may comprise step S510, S520, and Step S530. However, the present disclosure is not limited thereto. In some other embodiments, the method 500 may comprise more steps, less steps, different steps or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where a first authentication request for the UE may be received from a second network node in the second network.

At step S520, whether the UE is successfully authenticated or not may be determined at least partially based on one or more authentication configurations for the first network.

At step S530, a first authentication response indicating whether the UE is successfully authenticated or not may be transmitted to the second network node based on a result of the determination.

In some embodiments, before the step S520, the method 500 may further comprise: transmitting, to a third network node at which the one or more authentication configurations are managed, an authentication configuration request for the UE; and receiving, from the third network node, an authentication configuration response comprising at least an authentication vector for authenticating the UE. In some embodiments, before the step S520, the method 500 may further comprise: transmitting, to the second network node, a second authentication request comprising a challenge for the UE, which is generated at least partially based on the authentication vector received from the third network node; and receiving, from the second network node, a second authentication response comprising a response to the challenge. In some embodiments, the step S520 may comprise: comparing the response received from the second network node and a correct response which is received in the authentication configuration response from the third network node or calculated at the first network node; and determining that the UE is successfully authenticated or not based on the comparison.

In some embodiments, the first authentication request and the first authentication response may be generated according to a first authentication framework, and the second authentication request and the second authentication response may be generated according to a second authentication framework different from the first authentication framework. In some embodiments, the first authentication framework may be 5th Generation—Authentication and Key Agreement (5G-AKA) or Extensible Authentication Protocol—Authentication and Key Agreement (EAP-AKA′), and the second authentication framework may be a Lightweight Directory Access Protocol (LDAP)-based framework. In some embodiments, before transmitting, to a third network node at which the one or more authentication configurations are managed, an authentication configuration request for the UE, the method 500 may further comprise: generating the authentication configuration request from the first authentication request.

In some embodiments, after the step of transmitting, to the second network node, a first authentication response, the method 500 may further comprise: transmitting, to the third network node, an authentication result confirmation request indicating the result of the authentication for the UE; and receiving, from the third network node, an authentication result confirmation response acknowledging the result of the authentication for the UE. In some embodiments, the first network node may be a Private Subscriber Authentication Function (PSAF), the second network node may be an Access and Mobility Management Function (AMF)/Security Anchor Function (SEAF), and the third network node may be an LDAP server in the first network. In some embodiments, the first network node may be a Private Subscriber Authentication Function (PSAF), the second network node may be an Access and Mobility Management Function (AMF)/Security Anchor Function (SEAF), and the third network node may be a Unified Data Management (UDM) in the second network. In some embodiments, the first network may be a private network operated by an enterprise, and the second network may be a network operated by a Mobile Network Operator (MNO).

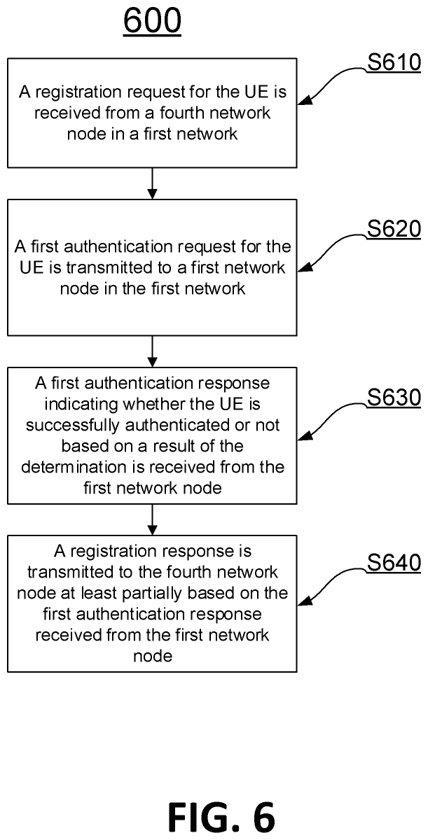

FIG. 6 is a flow chart of an exemplary method 600 at a second network node in a second network for jointly authenticating a UE in a first network and the second network according to an embodiment of the present disclosure. The method 600 may be performed at a second network node (e.g., the AMF/SEAF 210) for joint authentication. The method 600 may comprise step S610, S620, S630, and S640. However, the present disclosure is not limited thereto. In some other embodiments, the method 600 may comprise more steps, less steps, different steps or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where a registration request for the UE may be received from a fourth network node in the first network.

At step S620, a first authentication request for the UE may be transmitted to a first network node in the first network.

At step S630, a first authentication response indicating whether the UE is successfully authenticated or not based on a result of the determination may be received from the first network node.

At step S640, a registration response may be transmitted to the fourth network node at least partially based on the first authentication response received from the first network node.

In some embodiments, before the step S630, the method 600 may further comprise: receiving, from the first network node, a second authentication request comprising a challenge for the UE; transmitting, to the fourth network node, the second authentication request; receiving, from the fourth network node, a second authentication response comprising a response to the challenge; and transmitting, to the first network node, the second authentication response. In some embodiments, the first network node may be a Private Subscriber Authentication Function (PSAF), the second network node may be an Access and Mobility Management Function (AMF)/Security Anchor Function (SEAF), and the fourth network node may be a radio access network (RAN) node. In some embodiments, the first network may be a private network operated by an enterprise, and the second network may be a network operated by a Mobile Network Operator (MNO).

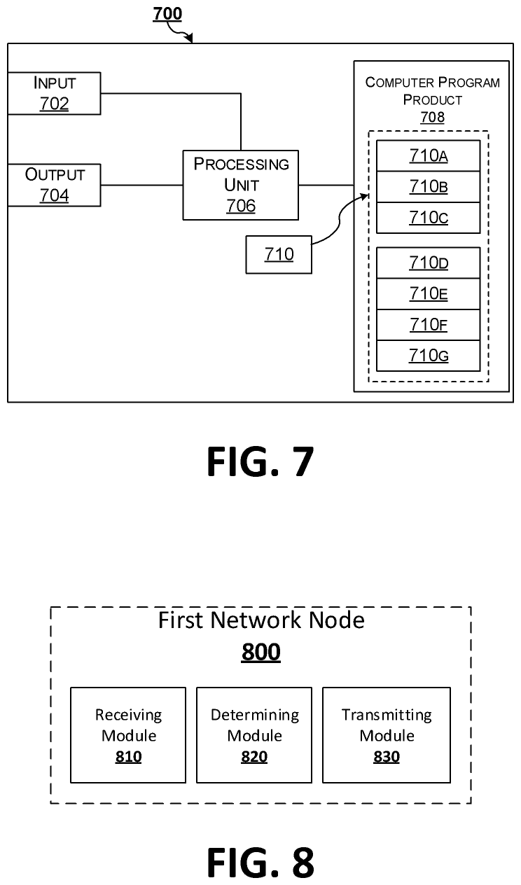

FIG. 7 schematically shows an embodiment of an arrangement 700 which may be used in a network node (e.g., the first network node or the second network node) according to an embodiment of the present disclosure. Comprised in the arrangement 700 are a processing unit 706, e.g., with a Digital Signal Processor (DSP) or a Central Processing Unit (CPU). The processing unit 706 may be a single unit or a plurality of units to perform different actions of procedures described herein. The arrangement 700 may also comprise an input unit 702 for receiving signals from other entities, and an output unit 704 for providing signal(s) to other entities. The input unit 702 and the output unit 704 may be arranged as an integrated entity or as separate entities.

Furthermore, the arrangement 700 may comprise at least one computer program product 708 in the form of a non-volatile or volatile memory, e.g., an Electrically Erasable Programmable Read-Only Memory (EEPROM), a flash memory and/or a hard drive. The computer program product 708 comprises a computer program 710, which comprises code/computer readable instructions, which when executed by the processing unit 706 in the arrangement 700 causes the arrangement 700 and/or the network nodes in which it is comprised to perform the actions, e.g., of the procedure described earlier in conjunction with FIG. 3 to FIG. 6 or any other variant.

The computer program 710 may be configured as a computer program code structured in computer program modules 710A, 710B, and 710C. Hence, in an exemplifying embodiment when the arrangement 700 is used in a first network node, the code in the computer program of the arrangement 700 includes: a module 710A for receiving, from a second network node in the second network, a first authentication request for the UE; a module 710B for determining whether the UE is successfully authenticated or not at least partially based on one or more authentication configurations for the first network; and a module 710C transmitting, to the second network node, a first authentication response indicating whether the UE is successfully authenticated or not based on a result of the determination.

Further, the computer program 710 may be configured as a computer program code structured in computer program modules 710D, 710E, 710F, and 710G. Hence, in an exemplifying embodiment when the arrangement 700 is used in a second network node, the code in the computer program of the arrangement 700 includes: a module 710D for receiving, from a fourth network node in the first network, a registration request for the UE; a module 710E transmitting, to a first network node in the first network, a first authentication request for the UE; a module 710F receiving, from the first network node, a first authentication response indicating whether the UE is successfully authenticated or not based on a result of the determination; and a module 710G transmitting, to the fourth network node, a registration response at least partially based on the first authentication response received from the first network node.

The computer program modules could essentially perform the actions of the flow illustrated in FIG. 3 to FIG. 6, to emulate the network nodes. In other words, when the different computer program modules are executed in the processing unit 706, they may correspond to different modules in the various network nodes.

Although the code means in the embodiments disclosed above in conjunction with FIG. 7 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

Correspondingly to the method 500 as described above, an exemplary first network node is provided. FIG. 8 is a block diagram of a first network node 800 according to an embodiment of the present disclosure. The first network node 800 may be, e.g., the PSAF 285 in some embodiments.

The first network node 800 may be configured to perform the method 500 as described above in connection with FIG. 5. As shown in FIG. 8, the first network node 800 may comprise a receiving module 810 for receiving, from a second network node in the second network, a first authentication request for the UE; a determining module 820 for determining whether the UE is successfully authenticated or not at least partially based on one or more authentication configurations for the first network; and a transmitting module 830 for transmitting, to the second network node, a first authentication response indicating whether the UE is successfully authenticated or not based on a result of the determination.

The above modules 810, 820, and/or 830 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the first network node 800 may comprise one or more further modules, each of which may perform any of the steps of the method 500 described with reference to FIG. 5.

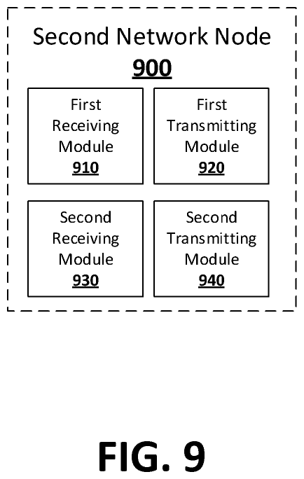

Correspondingly to the method 600 as described above, an exemplary second network node is provided. FIG. 9 is a block diagram of a second network node 900 according to an embodiment of the present disclosure. The second network node 900 may be, e.g., the AMF/SEAF 210 in some embodiments.

The second network node 900 may be configured to perform the method 600 as described above in connection with FIG. 6. As shown in FIG. 9, the second network node 900 may comprise a first receiving module 910 for receiving, from a fourth network node in the first network, a registration request for the UE; a first transmitting module 920 for transmitting, to a first network node in the first network, a first authentication request for the UE; a second receiving module 930 for receiving, from the first network node, a first authentication response indicating whether the UE is successfully authenticated or not based on a result of the determination; and a second transmitting module 940 for transmitting, to the fourth network node, a registration response at least partially based on the first authentication response received from the first network node.

The above modules 910, 920, 930, and/or 940 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the second network node 900 may comprise one or more further modules, each of which may perform any of the steps of the method 600 described with reference to FIG. 6.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| TPM | Trusted Platform Module |
| AD | Active Directory |
| LDAP | Lightweight Directory Access Protocol |

1. A method at a first network node in a first network for jointly authenticating a user equipment in the first network and a second network, the method comprising:
receiving, from a second network node in the second network, a first authentication request for the UE;
determining whether the UE is successfully authenticated or not at least partially based on one or more authentication configurations for the first network; and
transmitting, to the second network node, a first authentication response indicating whether the UE is successfully authenticated or not based on a result of the determination.

2. The method of claim 1, wherein before the step of determining whether the UE is successfully authenticated or not, the method further comprises:
transmitting, to a third network node at which the one or more authentication configurations are managed, an authentication configuration request for the UE; and
receiving, from the third network node, an authentication configuration response comprising at least an authentication vector for authenticating the UE.

3. The method of claim 2, wherein before the step of determining whether the UE is successfully authenticated or not, the method further comprises:
transmitting, to the second network node, a second authentication request comprising a challenge for the UE, which is generated at least partially based on the authentication vector received from the third network node; and
receiving, from the second network node, a second authentication response comprising a response to the challenge.

4. The method of claim 3, wherein the step of determining whether the UE is successfully authenticated or not comprises:
comparing the response received from the second network node and a correct response which is received in the authentication configuration response from the third network node or calculated at the first network node; and
determining that the UE is successfully authenticated or not based on the comparison.

5. The method of claim 2, wherein the first authentication request and the first authentication response are generated according to a first authentication framework, and the second authentication request and the second authentication response are generated according to a second authentication framework different from the first authentication framework.

6. The method of claim 5, wherein the first authentication framework is 5th Generation—Authentication and Key Agreement or Extensible Authentication Protocol—Authentication and Key Agreement, and the second authentication framework is a Lightweight Directory Access Protocol-based framework.

7. The method of claim 5, wherein before transmitting, to a third network node at which the one or more authentication configurations are managed, an authentication configuration request for the UE, the method further comprises:
generating the authentication configuration request from the first authentication request.

8. The method of claim 2, wherein after the step of transmitting, to the second network node, a first authentication response, the method further comprises:
transmitting, to the third network node, an authentication result confirmation request indicating the result of the authentication for the UE; and
receiving, from the third network node, an authentication result confirmation response acknowledging the result of the authentication for the UE.

9. The method of claim 1, wherein the first network node is a Private Subscriber Authentication Function, the second network node is an Access and Mobility Management Function/Security Anchor Function, and the third network node is an LDAP server in the first network.

10. The method of claim 1, wherein the first network node is a Private Subscriber Authentication Function, the second network node is an Access and Mobility Management Function/Security Anchor Function, and the third network node is a Unified Data Management in the second network.

11. The method of claim 1, wherein the first network is a private network operated by an enterprise, and the second network is a network operated by a Mobile Network Operator.

12. A first network node, comprising:
a processor;
a memory storing instructions which, when executed by the processor, enables the first network node to perform the method of claim 1.

13. A method at a second network node in a second network for jointly authenticating a user equipment in a first network and the second network, the method comprising:
receiving, from a fourth network node in the first network, a registration request for the UE;
transmitting, to a first network node in the first network, a first authentication request for the UE;
receiving, from the first network node, a first authentication response indicating whether the UE is successfully authenticated or not based on a result of the determination; and
transmitting, to the fourth network node, a registration response at least partially based on the first authentication response received from the first network node.

14. The method of claim 13, wherein before the step of receiving, from the first network node, a first authentication response, the method further comprises:
receiving, from the first network node, a second authentication request comprising a challenge for the UE;
transmitting, to the fourth network node, the second authentication request;
receiving, from the fourth network node, a second authentication response comprising a response to the challenge; and
transmitting, to the first network node, the second authentication response.

15. The method of claim 13, wherein the first network node is a Private Subscriber Authentication Function, the second network node is an Access and Mobility Management Function/Security Anchor Function, and the fourth network node is a radio access network node.

16. The method of claim 13, wherein the first network is a private network operated by an enterprise, and the second network is a network operated by a Mobile Network Operator.

17. A second network node, comprising:
a processor;
a memory storing instructions which, when executed by the processor, enables the second network node to perform the method of claim 13.

18. A non-transitory computer readable storage medium storing a computer program comprising instructions which, when executed by at least one processor, of a network node enables the network node to perform the method of claim 1.

19. A non-transitory computer readable storage medium storing a computer program comprising instructions which, when executed by at least one processor of a network node enables the network node to perform the method of claim 13.

20. (canceled)
